(19) United States
(12) Patent Application Publication
(10) Pub. No.: US 2024/0308155 A1
(43) Pub. Date: Sep. 19, 2024

(54) Process for Producing a Fiber-Reinforced Three-Dimensional Ceramic Component

(71) Applicant: Kyocera Fineceramics Europe GmbH, Mannheim (DE)

(72) Inventors: Pedro Silva Da Lima, Rehau (DE); Nikolaos Katsikis, Pleussen (DE); Sarah Diener, Selb (DE)

(21) Appl. No.: 18/603,666

(22) Filed: Mar. 13, 2024

(30) Foreign Application Priority Data
Mar. 15, 2023 (EP) 23161987.5

(51) Int. Cl. B29C 70/38; B29C 70/12; B33Y 10/00; B33Y 30/00; B33Y 70/10

(52) U.S. Cl. CPC B29C 70/382; B29C 70/12; B33Y 10/00; B33Y 30/00; B33Y 70/10

(57) ABSTRACT

The present invention relates to a process for producing a fiber-reinforced three-dimensional ceramic component allowing for a targeted orientation of the reinforcing fibers, a slip for use in said process according to the invention, and a device for carrying out the process according to the invention.

The present invention relates to a process for producing a fiber-reinforced three-dimensional ceramic component allowing for a targeted orientation of the reinforcing fibers, a slip for use in said process according to the invention, and a device for carrying out the process according to the invention.

Composite materials consist of a matrix and reinforcing fibers, and are acknowledged, above all, for their mechanical properties, which result from the interplay between the reinforcing fibers and the matrix surrounding them. While natural composite materials, which often consist of complex fiber arrangements in continuous matrices, may have exceptional mechanical properties, the mechanical properties of synthetic composite materials are usually non-isotropic because of the unidirectional orientation of the fibers. Although additive manufacturing methods offer a high flexibility in the production of tailored three-dimensional components, they reach their limits in terms of fiber content and oriented incorporation of the fibers.

In their article “Rotational 3D printing of damage-tolerant composites with programmable mechanics”, issued in PNAS, vol. 115, No. 6, pages 1198-1203, J.R. Raney et al. describe a 3D rotational printing process that is supposed to enable the spatially controlled orientation of fibers in polymer matrices by varying the nozzle rotational speed in proportion to the printing speed. With this method, composite materials that consist of volume units with programmably defined fiber arrangements are said to be accessible, including adjacent regions of fibers with orthogonal and helical orientations.

The process described by J.R. Raney has the disadvantages that only polymers are employed, that the length of the fibers is limited by the layer thickness during the printing, and that the fibers cannot be incorporated beyond the layer boundaries.

Although a higher charging with fibers can be achieved by the constructing layers ply by ply, the orientation of the fibers is always effected in the direction of applying. Therefore, the use of fibers provides a benefit only when the stress direction is one-dimensional, since all the fibers are uniformly oriented in the x direction. In contrast, there is hardly any reinforcement for unidirectional stresses.

Therefore, it would be desirable to have a process available that offers the possibility of orienting the fibers not only in the x direction, but also in the y and z directions, as well as in intermediate positions, and if possible, this should be adaptable through the height of the component.

This need is responded by the present invention by providing a process that allows for different orientations of fibers, and offers the possibility of fibers passing through different layers.

Therefore, the present invention firstly relates to a process for producing a fiber-reinforced component by additive manufacturing, wherein said process includes the layerwise construction of the component from a powdery material, characterized in that at least two of the layers have different orientations of the fibers.

Surprisingly, it has been found that not only could the concentration of reinforcing fibers be increased in this way, but a targeted orientation of the fibers in all directions is also possible. Thus, it is possible to adapt the mechanical properties of the component, such as impact resistance, strength, modulus of elasticity, and CTE, depending on demands, and to minimize component failure.

Within the scope of the process according to the invention, the fibers are preferably provided together with the powdery material, and delivered in layers together with the latter. In an equivalently or alternatively preferred embodiment, the fibers are injected into one or more layers of the powdery materials that have already been delivered, which offers the advantage that the fibers can be incorporated independently of the direction of delivery, for example, diagonally, and with passing from one layer to another. In a particularly preferred embodiment, the process according to the invention includes a combination of such methods.

In a preferred embodiment, the process according to the invention includes the following steps:
a) providing a first mixture including a powdery material and reinforcing fibers;
b) delivering said first mixture in a first layer, wherein said reinforcing fibers have a first orientation;
c) providing a further mixture including a powdery material and reinforcing fibers;
d) delivering said further mixture in a further step, in which said reinforcing fibers have a second orientation that is different from said first orientation;
e) optionally repeating steps b) and d) to obtain said fiber-reinforced three-dimensional component.

The orientation of the reinforcing fibers in x and y directions can be achieved, for example, by changing the orientation of the direction of application of the mixture with respect to the building platform. In a preferred embodiment of the process according to the invention, therefore, the different orientations of the reinforcing fibers are achieved by changing the direction of application of the mixture. In an alternatively preferred embodiment, the different orientations of the reinforcing fibers in the component are achieved by rotating the building platform onto which the mixture is delivered. In a particularly preferred embodiment, the different orientations of the reinforcing fibers are achieved by changing the direction of application of the mixture and/or by rotating the building platform.

Changing the direction of application of the mixture can achieve a free orientation of the reinforcing fibers in x and y directions. In addition, a targeted orientation in the z direction would be desirable. Surprisingly, it has been found that this can be achieved by purposefully injecting reinforcing fibers into layers that have already been delivered. Therefore, an embodiment of the process according to the invention is preferred in which said process further includes an injection step, in which reinforcing fibers are injected into one or more delivered layers, in which the injected reinforcing fibers preferably have a third orientation, which is different from the orientation of any fibers that may be present.

Injecting the reinforcing fibers can not only achieve an orientation in a further direction of space, but it is thus also possible to incorporate reinforcing fibers that extend through several layers. Therefore, an embodiment of the process according to the invention is preferred in which the injection is effected in such a way that the reinforcing fibers extend through at least two layers, preferably bonding them to one another. Thus, a three-dimensional distribution of the reinforcing fibers within the component can be achieved by varying the angle of the impinging direction.

In order to be able to adapt the properties of the component according to need, it has proven advantageous to employ different powdery materials. Therefore, an embodiment is preferred in which the materials employed are the same, or different. Further, additional materials that do not contain any reinforcing fibers may preferably be delivered. In this manner, the mechanical properties of the component can be adapted individually and with spatial resolution.

The process according to the invention is particularly suitable for the production of ceramic components. Therefore, an embodiment is preferred in which said powdery material is selected from the group consisting of the oxides, carbides and nitrides of metals and non-metals. Silicon carbide has found a broad range of applications because of its hardness and high temperature stability, but also represents a particular challenge in the processing. Surprisingly, it has been found that the process according to the invention is also suitable for the production of components based on silicon carbide. Therefore, an embodiment is particularly preferred in which said powdery material is silicon carbide.

The conventional additive methods have the disadvantage that the length of the reinforcing fibers is mostly limited by the layer thickness of the delivered layer. Within the scope of the process according to the invention, it has surprisingly been found that longer reinforcing fibers may also be incorporated, and thus the individual layers can be bonded in an overlapping mode when the fibers are delivered with an offset. In order to be able to incorporate longer reinforcing fibers, in addition to injecting, it has proven advantageous to use a slot die for producing the layer. Thus, reinforcing fibers can be incorporated that protrude from the delivered layer and are immersed in the next layer. Therefore, an embodiment is preferred in which the delivery of the mixture is effected by using a slot die.

Within the scope of the process according to the invention, it has surprisingly been found that reinforcing fibers having a length of up to 1 mm can be processed. In the process according to the invention, reinforcing fibers having a length of 1 mm or less are preferably used. In this way, it can be achieved that the reinforcing fibers extend through several layers, without affecting the printing precision.

Within the scope of the process according to the invention, it has surprisingly been found that the charging amount of reinforcing fibers can be significantly increased over conventional processes. Therefore, an embodiment is preferred in which the proportion of reinforcing fibers is 10 to 60% by volume, preferably 15 to 55% by volume, based on the total volume of the component.

In the process according to the invention, commonly used reinforcing fibers may be employed. In a preferred embodiment, the reinforcing fibers are selected from the group consisting of glass fibers, polymer fibers, carbon fibers, and ceramic fibers, especially silicon carbide (SiC) fibers.

Surprisingly, it has been found that the process according to the invention can be applied to both classical powder bed fusion methods and slip-based methods. Over classical powder bed fusion methods, the slip-based method offers the advantage that components having a lower porosity can be obtained. Therefore, an embodiment is preferred in which the powdery material is provided in the form of a slip, in which said slip preferably further includes reinforcing fibers in addition to said powdery material.

Within the scope of the slip-based embodiment of the process according to the invention, the latter preferably comprises another step in which the moisture content of the slip is reduced. The moisture content can be reduced to a desired degree, especially to dryness. The reduction is preferably effected by using thermal methods and/or by means of absorbent substrates.

In order to achieve an initial stability of the component and a bonding between the individual layers, the layers may be sintered, for example, using a laser. Alternatively, a binder may also be employed. Therefore, in a preferred embodiment, the process according to the invention further comprises the delivery of a binder according to a cross-section of the component, wherein said binder is preferably delivered between each two adjacent powder layers. In an alternatively preferred embodiment, the binder is delivered together with the powder in the form of a mixture. Further, the process according to the invention preferably comprises at least one step of curing the binder. The curing of the binder may be effected in a way known to those skilled in the art, for example, thermally or by irradiation, for example, by using a laser.

The process according to the invention may be slip-based, whereby components having a lower porosity as compared to powder printing can be obtained. Following up this idea, the present invention further relates to a slip for use in the process according to the invention, wherein said slip includes
a) ceramic particles, preferably SiC particles;
b) reinforcing fibers, and
c) binders.

The ceramic particles are preferably selected from the group consisting of oxide ceramics, nitride ceramics, and carbide ceramics, and mixtures thereof, especially silicon carbide. In addition to the ceramic particles, other components may be contained, especially those selected from the group consisting of diamond particles, graphite, carbon black, and organic compounds, and mixtures thereof.

The reinforcing fibers are preferably selected from the group consisting of glass fibers, carbon fibers, and ceramic fibers, especially silicon carbide (SiC) fibers.

The binder preferably includes one or more of the compounds selected from the group consisting of resins, especially phenolic resins, polysaccharides, polyvinyl alcohol, cellulose and cellulose derivatives, lignin sulfonates, polyethylene glycol, polyvinyl derivatives, polyacrylates, and mixtures thereof.

The present invention further relates to a component obtainable by the process according to the invention, in which said component has an isotropic orientation and/or distribution of the reinforcing fibers.

The present invention further relates to a device for carrying out the process according to the invention and/or for producing the component according to the invention. The device has a delivery unit for delivering a powdery material and optionally reinforcing fibers, and a height-adjustable receiving unit for receiving a layer of the powdery material, in which said delivery unit and/or said receiving unit are movable in a plane, preferably rotatable.

In a preferred embodiment, the delivery unit is a die, especially a slot die, or a doctor blade.

In a further preferred embodiment, the device according to the invention further has an injection unit for injecting reinforcing fibers into one or more layers.

In another aspect, the present invention further relates to the use of a slip for producing a fiber-reinforced ceramic component by additive manufacturing, preferably by the process according to the invention, wherein said slip includes
a) ceramic particles, preferably SiC particles;
b) reinforcing fibers, and
c) binders.

The components of the slip are preferably those described above.

The present invention is described by means of the following Figures, which should by no means be understood as limiting the idea of the invention.

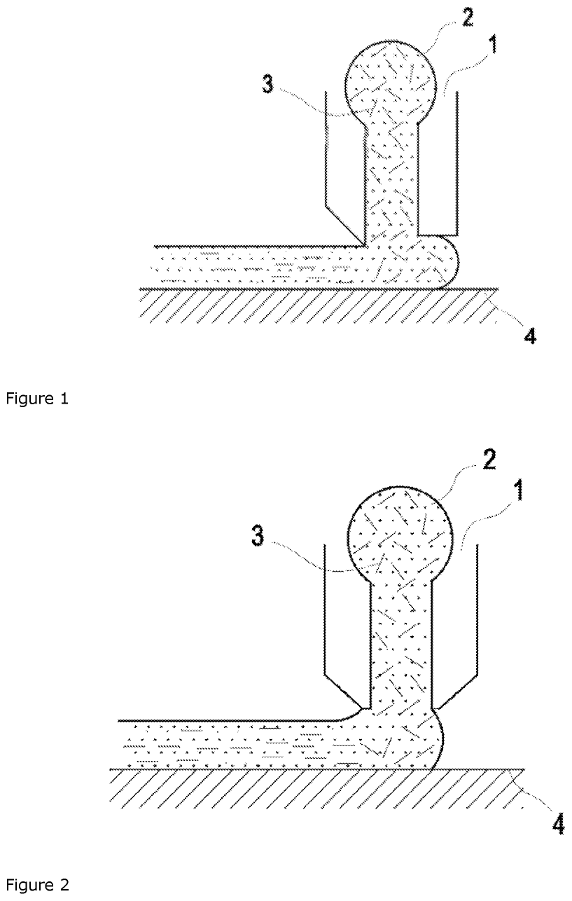

FIG. 1 shows the schematic structure of an embodiment of the device according to the invention with a delivery unit (1) in the form of a doctor blade, in which a powdery material (2) with reinforcing fibers (3) is delivered on a substrate or a previous powder layer (4), and said reinforcing fibers have a first preferred orientation.

FIG. 2 shows the schematic structure of an embodiment of the device according to the invention with a delivery unit (1) in the form of a slot die, in which a powdery material (2) with reinforcing fibers (3) is delivered on a substrate or a previous powder layer (4), and said reinforcing fibers have a first preferred orientation.

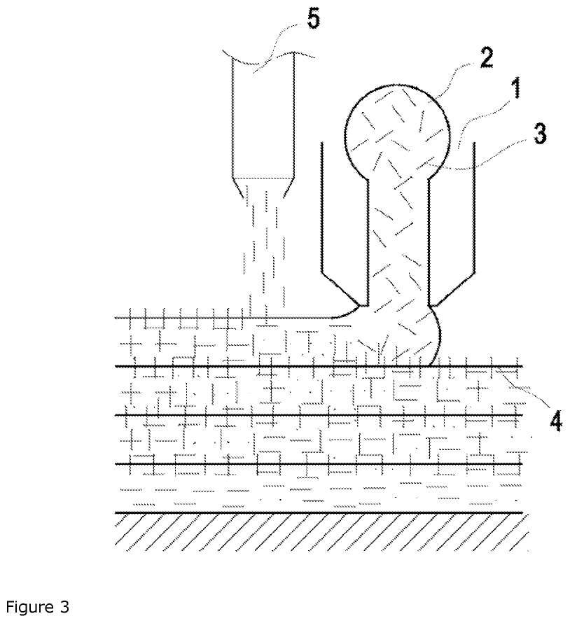

FIG. 3 shows the schematic structure of an embodiment of the device according to the invention with a delivery unit (1) in the form of a slot die, and an injection unit (5), in which a powdery material (2) with reinforcing fibers (3) is delivered on a substrate or a previous powder layer (4), and said reinforcing fibers have different orientations, and the reinforcing fibers (3) incorporated by using the injection unit (5) extend beyond the layer thickness of one layer in the z direction.

In each of the embodiments described, the powdery material (2) can be employed in the form of a slip.

1. A process for producing a fiber-reinforced three-dimensional component by additive manufacturing, wherein said process includes the layerwise construction of the component from a powdery material, characterized in that at least two of the layers have different orientations of reinforcing fibers.

2. The process according to claim 1, characterized in that the reinforcing fibers are provided together with the powdery material, and delivered in layers together with the latter, and/or said reinforcing fibers are incorporated in one or more layers by injection.

3. The process according to claim 1, characterized in that the different orientations of said reinforcing fibers are achieved by changing the direction of application of the powdery material.

4. The process according to claim 1, characterized in that said reinforcing fibers extend through at least two layers.

5. The process according to claim 1, characterized in that said reinforcing fibers have a length of 1 mm or less.

6. The process according to claim 1, characterized in that the proportion of reinforcing fibers is 10 to 60% by volume based on the total volume of the component.

7. The process according to claim 1, characterized in that the reinforcing fibers are selected from the group consisting of glass fibers, polymer fibers, carbon fibers, and ceramic fibers.

8. The process according to claim 1, characterized in that the powdery material is provided in the form of a slip.

9. The process according to claim 1, characterized in that said powdery material is selected from the group consisting of oxides, carbides and nitrides of metals and transition metals, and mixtures thereof.

10. A slip for use in a process according to claim 1, characterized in that said slip includes:
a) ceramic particles, preferably SiC particles;
b) reinforcing fibers; and
c) binders.

11. A fiber-reinforced ceramic component obtainable by a process according to claim 1, characterized in that said component has an isotropic orientation and/or distribution of the reinforcing fibers.

12. A device for carrying out a process according to claim 1, comprising a delivery unit for delivering a powdery material and optionally the reinforcing fibers, and a height-adjustable receiving unit for receiving a layer of the powdery material, in which said delivery unit and/or said receiving unit are movable in a plane.

13. The device according to claim 12, characterized in that said delivery unit is a die or a doctor blade.

14. The device according to claim 12, characterized in that the device further has an injection unit for injecting the reinforcing fibers into the one or more layers.

15. The use of a slip for producing a fiber-reinforced ceramic component according to claim 11, wherein said slip includes
a) ceramic particles;
b) the reinforcing fibers, and
c) one or more binders.

16. The process according to claim 1, characterized in that the proportion of the reinforcing fibers is 15 to 55% by volume based on the total volume of the component.

17. The process according to claim 1, characterized in that the reinforcing fibers are silicon carbide (SiC) fibers.

18. The process according to claim 8, characterized in that the slip further includes the reinforcing fibers.

19. A device for carrying out a process for producing a component according to claim 11, comprising a delivery unit for delivering a powdery material and optionally the reinforcing fibers, and a height-adjustable receiving unit for receiving a layer of the powdery material, in which said delivery unit and/or said receiving unit are movable in a plane.

20. The device according to claim 12, characterized in that the die is a slot die.
